(19) United States
(12) Patent Application Publication
(10) Pub. No.: US 2014/0289241 A1
(43) Pub. Date: Sep. 25, 2014

(54) SYSTEMS AND METHODS FOR GENERATING A MEDIA VALUE METRIC

(71) Applicant: Spotify AB, Stockholm (SE)

(72) Inventor: James Anderson, New York, NY (US)

(73) Assignee: Spotify AB, Stockholm (SE)

(21) Appl. No.: 14/218,354

(22) Filed: Mar. 18, 2014

Related U.S. Application Data
(60) Provisional application No. 61/800,759, filed on Mar. 15, 2013.

(51) Int. Cl. G06F 17/30

(52) U.S. Cl. CPC G06F 17/3002
USPC 707/736

(57) ABSTRACT

Systems and methods for determining a media engagement metric for a media content item are described. Respective exposure times for one or more respective segments of a media content item are received from each of one or more users, wherein the media content item is divided into a plurality of respective segments. For each user of the one or more users, a media engagement metric is generated for each of the plurality of segments of the media content item, wherein generating the media engagement metric includes standardizing the respective exposure times based at least in part on a characteristic consumption time for each respective segment of the media content item. For each of the one or more users, the media engagement metric for each of the plurality of segments of the media content item is stored in association with a user identifier.

### CROSS-REFERENCE

This application claims priority to U.S. Provisional Application No. 61/800,759, filed Mar. 15, 2013, the contents of which are incorporated herein by reference in its entirety.

### TECHNICAL FIELD

The disclosed implementations relate generally to tracking exposure to media content, and more specifically, to tracking the level of user engagement with media content.

### BACKGROUND

Tracking exposure to media content is an important tool in the modern economy. For example, television networks want to know how many people are watching shows on their network. Radio stations want to know how many people are listening to their station. Internet content providers want to know how many people are reading their websites. Magazine and newspaper publishers want to know how many people are reading their publications.

The information gleaned from tracking such exposure is used for many reasons, such as to determine the desirability of particular media content in order to set advertising rates. The information can also be used, for example, to track user preferences and trends, both for individual users (e.g., determining an interest profile for a particular user) and for groups of users (e.g., determining an interest profile for users in a particular region).

Many existing techniques for tracking media exposure rely on the concept of “impressions,” or how many people “see” the content. For example, the number of impressions of a webpage is simply the number of times that the webpage has been visited. However, counting impressions of media content provides only very coarse exposure data. In particular, it can be difficult to determine whether a user actually read and consumed the content on a webpage or simply loaded the webpage and walked away from the computer. Moreover, simple impression counts do not reflect the extent to which users consume different portions of a content item, such as whether a user read only the first paragraph of an online article. Even if the amount of time that users consume a particular media content item can be determined (e.g., how long a user spent on a particular webpage), the differences in the speeds at which users consume media and the degrees to which they engage with media reduces the effectiveness of any generalizations or comparisons based on such data.

Accordingly, it would be useful to improve media exposure tracking techniques to acquire more useful exposure data and improve data analytics techniques to generate more useful exposure tracking metrics from that data.

### SUMMARY

The present application describes systems and methods for acquiring and analyzing media exposure and consumption data. In particular, the present application describes segmenting media content items into multiple segments and acquiring exposure and interaction data for each of the multiple segments. For example, instead of simply measuring how many users visit a webpage and how long they spend on the webpage, the described systems and methods measure how users consume various segments of the webpage, such as how long each individual spends reading particular paragraphs of the webpage (or other segments, such as columns, frames, etc.). As another example, instead of simply measuring how many users view a particular video, the described systems and methods measure how many users consume various segments of the video (e.g., corresponding to chapters, scenes, etc.), as well as how they interact with each segment (e.g., whether the video is paused within that subsection, whether the user “fast-forwards” through part of that subsection, etc.). Such techniques result in exposure data of finer granularity than simply measuring exposure to content items in their entirety.

Collecting data for segments of a media content item—rather than entire media content items—allows greater visibility into how users are consuming that media content item. For example, such data can be used to generate engagement profiles that represent how user engagement with the content item varies among the different segments. Specifically, engagement profiles can show whether user interest increases, decreases, or stays consistent throughout the various segments of the content item.

The present application further describes systems and methods for generating engagement metrics (e.g., measures of how well or how much a user engages with, views, and/or otherwise consumes content) from media exposure and consumption data that account for differences in how users interact with and consume media content. In particular, different users may consume content at different speeds. Thus, the amount of time that a given user is exposed to a media content item does not necessarily provide a good metric for how well that user has engaged with or consumed the content. For example, a fast reader may fully engage with or consume (i.e., read and comprehend) a segment of text in 30 seconds, while another user may require two minutes. A comparison of these raw values incorrectly suggests that the fast reader did not fully engage with the content. Accordingly, exposure times (as well as other engagement metrics) can be standardized for individuals or groups of users in order to account for differences in their interaction habits.

Interaction habits are determined based on historical data for individuals or groups. For example, if a user has a history of consuming content faster than a global average rate, the measured exposure times for that user can be adjusted to account for the difference between the user's average and the global average. Such techniques are also applied to groups of users. For example, when looking at how users of a particular group tend to engage with a particular media content item, historical data about how that group consumes and/or engages with media can be compared to a global average rate in order to scale the data accordingly. As a specific example, if a media content provider wants to know how well a blog post is received by a group of college professors (who might tend to read faster than the global average), raw exposure times may mislead the content provider into thinking that the group did not fully engage with or consume the blog post. Thus, the exposure times for the group of college professors are adjusted to account for the difference between their historical average reading rate and the global average reading rate.

While the foregoing discussion describes standardizing exposure times, the same or similar techniques also apply to other engagement metrics. One type of interaction that can suggest a level of engagement with media on a computer is cursor activity. For example, if a user is highlighting text as they read, it may indicate that they are more engaged with the content than someone who is simply scrolling down a webpage. Thus, cursor activity (e.g., text highlighting) of a user or group can be standardized with respect to a global average value to avoid skewing the results.

The present application further describes systems and methods for generating engagement metrics that account for differences in the media content items themselves. In particular, it is not particularly useful to compare raw exposure times for different content items, because each content item will have different lengths, different information densities, and the like. For example, a 500 word news article may contain more difficult grammar, sentence structure, as well as more and more difficult concepts than a 500 word blog posting about celebrity gossip. Thus, while it may take a group of users an average of three minutes to fully consume the news article, it may take that same group an average of one minute to fully consume the blog post. Accordingly, comparing raw exposure times between these two content items will not necessarily reflect the degree to which users engaged with or consumed the content.

In order to account for the inherent differences between content items, techniques are provided for determining a characteristic consumption time for media content items. For example, given the news article and the blog post described above, it is determined that, given an average reading rate and the density of the information in each content item, the characteristic consumption times are three minutes for the news article and one minute for the blog post. Thus, measured media exposure times can be adjusted to account for the differences in characteristic consumption times in order to provide a metric that is consistent across different media content items.

Characteristic consumption times are useful when comparing exposure times of text based media or other media where time of engagement is a reasonable heuristic for a user's level of engagement with the content (i.e., where more time generally indicates more engagement). For some content, such as audio and video content, exposure time is less useful because the content itself has a fixed duration. Thus, the time for complete consumption of the content tends to be the same for all users, and it can be difficult to tell, based on exposure time alone, the extent to which users have actually engaged with or consumed the content (e.g., it will be difficult to tell whether one user actually watched a video in a webpage or simply let it run on the webpage while engaging in a different activity). Accordingly, other heuristics for measuring engagement with media content are also standardized to account for differences in the information density and characteristic engagement activities between media content items. As one specific example, different games may require different amounts of user interaction (e.g., mouse movements, key presses, etc.) in order for the user to have been fully engaged with (or fully consumed) the content. Thus, a characteristic engagement value can be established for each game and used to standardize measured engagement values from a group of users.

### Exemplary Implementations

A method is provided for determining a media engagement metric for a media content item, performed at a server computer system having one or more processors and memory storing one or more programs for execution by the one or more processors, the method includes receiving, from each of one or more users, respective exposure times for one or more respective segments of a media content item, wherein the media content item is divided into a plurality of respective segments; generating, for each user of the one or more users, a media engagement metric for each of the plurality of segments of the media content item, wherein generating the media engagement metric includes standardizing the respective exposure times based at least in part on a characteristic consumption time for each respective segment of the media content item; and storing, for each of the one or more users, the media engagement metric for each of the plurality of segments of the media content item in association with a user identifier.

In some implementations, the method further includes determining the characteristic consumption time for each respective segment of the media content item, wherein the characteristic consumption time for a respective segment of the media content item is based at least in part on a length of the respective segment and an information density of the respective segment.

In some implementations, the characteristic consumption time for each respective segment represents an exposure time corresponding to complete consumption of the respective segment by a hypothetical user.

In some implementations, the respective segment includes text, and the information density is based at least in part on the vocabulary and the sentence construction of the text. In some implementations, the respective segment is a photograph, and the information density is based at least in part on the complexity of the image in the photograph. In some implementations, the respective segment is a portion of a video, and the information density is based at least in part on a factor selected from the group consisting of: an amount of dialog in the segment; complexity of dialogue in the segment; whether the segment includes an action sequence; and the location of the segment in the video.

In some implementations, generating the media engagement metric further includes standardizing the respective exposure times based at least in part on a historical average consumption rate of the one or more users.

In some implementations, the one or more users corresponds to all users for which exposure times for the respective segments of the media content item are available. In some implementations, the one or more users corresponds to a plurality of users having a common psychographic group. In some implementations, the one or more users corresponds to a plurality of users in a particular age range. In some implementations, the one or more users corresponds to a single user.

In some implementations, the method further includes predicting an engagement level for an additional media content item based at least in part on similarities between the media content item and the additional media content item.

In some implementations, the method further includes determining an engagement profile for the media content item based on the media engagement metrics for each of the plurality of segments of the media content item.

In some implementations, the media content item includes text, and wherein each segment of the plurality of respective segments corresponds to a respective textual segment of the text. In some implementations, the media content item is a video, and wherein each segment of the plurality of respective segments corresponds to a respective video segment of the video. In some implementations, the media content item is a plurality of images, and wherein each segment of the plurality of respective segments corresponds to a respective image of the plurality of images. In some implementations, the media content item is a game, and wherein each segment of the plurality of respective segments corresponds to a respective gameplay segment of the game.

In some implementations, the method further includes generating a consolidated media engagement metric for the media content item based at least in part on the media engagement metrics for each of the plurality of segments of the media content item.

In accordance with some implementations, a computer system (e.g., a client system or server system) includes one or more processors, memory, and one or more programs; the one or more programs are stored in the memory and configured to be executed by the one or more processors and the one or more programs include instructions for performing the operations of the method described herein. In accordance with some implementations, a non-transitory computer readable storage medium has stored therein instructions which when executed by one or more processors, cause a computer system (e.g., a client system or server system) to perform the operations of the methods described herein.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 is a block diagram illustrating a client-server environment in accordance with some implementations.

FIG. 2 is a block diagram illustrating a client device, in accordance with some implementations.

FIG. 3 is a block diagram illustrating a content server, in accordance with some implementations.

FIG. 4 is a block diagram illustrating an exposure tracking server, in accordance with some implementations.

FIG. 5 is a flowchart of a method for determining a media engagement metric, in accordance with some implementations.

### DETAILED DESCRIPTION

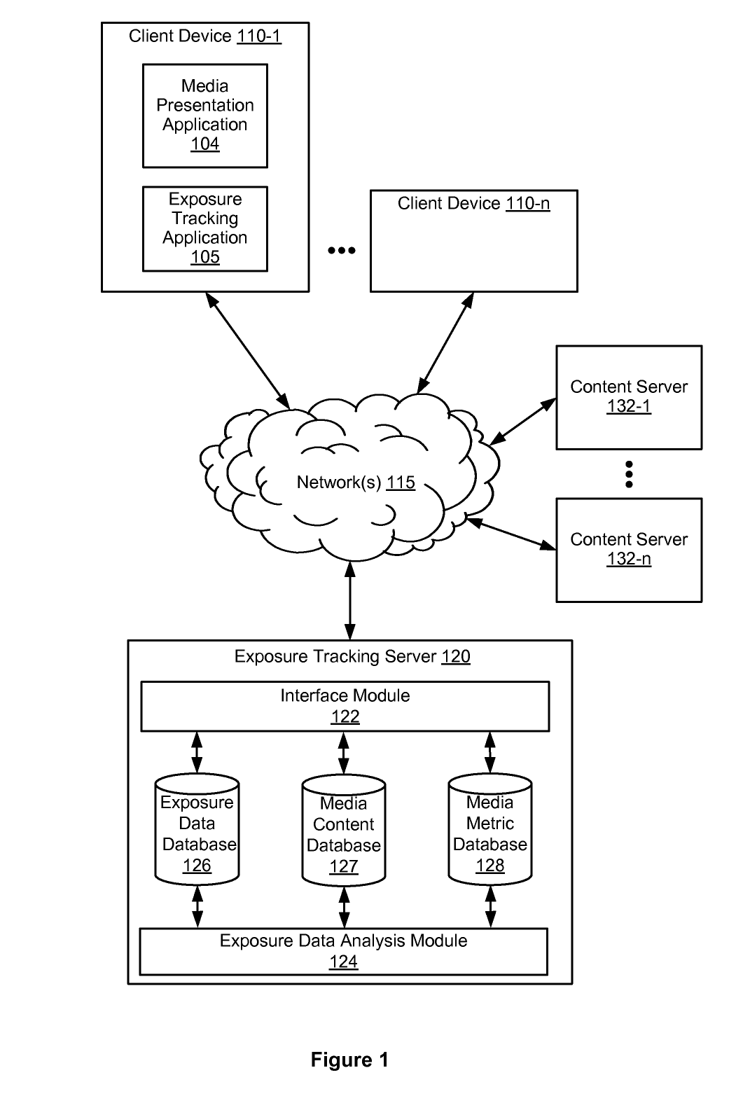

FIG. 1 is a block diagram of a client-server environment 100 in accordance with some implementations. The client-server environment 100 includes one or more client devices 110 (e.g., 110-1, . . . , 110-n), one or more exposure tracking server(s) 120, and one or more content servers 132 (132-1, . . . , 132-n) that are connected through one or more networks 115. The one or more networks 115 can be any network (or combination of networks) such as the Internet, other Wide Area Networks, Local Area Networks, Personal Area Networks, metropolitan area networks, VPNs, local peer-to-peer, ad-hoc connections, and so on.

The client device 110-1 is a representative electronic device associated with a respective user. In some implementations, the client device 110-1 is one of the group of: a personal computer, a television, a set-top box, a mobile electronic device, a wearable computing device, a laptop, a tablet computer, a mobile phone, a digital media player, or any other electronic device able to prepare media content for presentation, control presentation of media content, and/or present media content. The client device 110-1 communicates with and receives content from content sources such as any of the one or more content servers 132.

In some implementations, the client device 110-1 includes a media presentation application 104 (hereinafter “media application”) that controls the presentation of media on an output device associated with the client device 110-1. (The output device may be part of the client device 110-1, such as built-in speakers or a screen of a laptop computer, or may be separate from the client device 110-1, such as a television coupled to a set-top box.)

The media application 104 is any appropriate program, firmware, operating system, or other logical or physical aspect of the client device 110-1 that enables presentation of media content by the client device 110-1 (e.g., on an output associated with the client device 110-1). For example, where the client device 110-1 is a computer (e.g., laptop computer, tablet computer, mobile phone, etc.), the media presentation application 104 may be a web browser, a video presentation application, a music presentation application, an email application, a media aggregation application, or the like.

In some implementations, the client device 110-1 also includes an exposure tracking application 105 (hereinafter “tracking application”). The tracking application 105 is configured to collect media exposure data and provide the collected data to the exposure tracking server 120. The tracking application 105 can be configured to track exposure to any appropriate type of media (e.g., webpages, music, movies, television shows, etc.) delivered via any appropriate medium (e.g., over-the-air broadcast, the Internet, etc.).

In some implementations, the tracking application 105 is stored on the client device 110-1 (e.g., in a similar manner to other applications, such as web browsers), and tracks users' exposure to one or more types of content.

In some implementations, the tracking application 105 is embedded into content that is received from a content server 132. For example, a webpage received from a content server 132 may include code that causes a web browser to report certain data to an exposure tracking server 120 (e.g., what portions of a webpage were actually displayed, and for how long, etc.). In some such cases, the tracking application 105 is only resident on the client device 110-1 as long as the content itself is stored on the client device 110-1.

The one or more content servers 132 store content and provide the content, via the network(s) 115, to the one or more client devices 110. Content stored by the one or more content servers 132 includes any appropriate content, including text (e.g., articles, blog posts, emails, etc.), images (e.g., photographs, drawings, renderings, etc.), videos (e.g., short-form videos, music videos, television shows, movies, clips, previews, etc.), audio (e.g., music, spoken word, podcasts, etc.), games (e.g., 2- or 3-dimensional graphics-based computer games, etc.), or any combination of content types (e.g., webpages including any combination of the foregoing types of content, or other content not explicitly listed).

The exposure tracking server 120 is a representative server associated with a media exposure tracking service that receives, stores, and manipulates data about users' exposure to, interaction with, and/or consumption of media content. The exposure tracking server 120 receives exposure data from the tracking applications 105 of the one or more client devices 110-1.

In some implementations, the exposure tracking server 120 includes an interface module 122, a mix rule module 124, an exposure data database 126, a media content database 127, and a media metric database 128.

The interface module 122 enables the exposure tracking server 120 to communicate with (e.g., send information to and/or receive information from) one or more of the client devices 110 and the content servers 132. In some implementations, the interface module 122 receives exposure data from a plurality of client devices 110 (e.g., from tracking applications 105 of the client devices 110). The interface module 122 stores the received exposure data in the exposure data database 126.

The exposure data analysis module 124 reads and/or extracts exposure data from the exposure data database 126 (or receives the exposure data directly from the interface module 122) and generates media metrics from the exposure data. Media metrics are described herein, and include standardized and/or normalized values representing a degree to which users have consumed and/or engaged with media content. The exposure data analysis module 124 stores the media metrics in the media metric database 128 in association with identifiers of the users and the content items to which they relate.

In some implementations, the exposure tracking server also stores content items in a media content database 127. The stored content items include, for example, content items for which exposure is to be or has been tracked.

In some implementations, the media metric database 128 also includes additional information about the users and the content items. For example, the media metric database 128 includes user profiles for one or more of the users, where the user profiles include user demographics (e.g., age, sex, location, etc.), user interest information (e.g., content preferences, purchase histories, download histories, media access histories, self-reported or derived interests, social group affiliations, likes, dislikes, etc.), and the like. As another example, the media metric database 128 includes characteristics and properties of the media content items to which exposure has been (or is to be) tracked, including media type(s) (e.g., video, text, graphic, interactive, combined, etc.), content tones/styles (e.g., satirical, humorous, serious, etc.), content genre (e.g., news, advertisement, television show, movie, general interest, etc.), and the like. In some implementations, information about content items is instead or additionally stored in the media content database 127.

Characteristics and properties of the media content items to which exposure has been (or is to be) tracked are stored separately from the media content items themselves, such as in a metadata database (e.g., metadata database 320). Where such information is stored separately from the media content items, the information is, in some cases, stored in association with a media content item identifier that can be used to identify the particular media content item(s) to which the information relates.

In some implementations, the exposure data analysis module 124 generates reports based on the media metrics and the additional information about the users and the content items. Such reports can show, for example, the types of content that a particular user or group of users finds particularly engaging or how well or how much a particular content item is liked or consumed by a particular group of users. As a specific example, a report can provide a listing of media engagement metrics from all “baby boomers” for various content tones/styles, which might indicate that “baby boomers” tend to prefer “serious” content over “satirical” content. As another example, a report can provide a listing of media metrics for an individual media content item from a plurality of different user groups. This report might show, for example, that a particular advertisement tends to be favored by “hipsters” but not by “baby boomers.”

In some implementations, the exposure tracking server 120 also stores and/or serves media content to client devices 110 (or any other appropriate device). For example, an exposure tracking server may include any or all of the functionality of a content server 132.

In some implementations, the exposure tracking server is associated with a media content provider that also provides one or more content servers 132. For example, a provider of a news website, which is stored and/or served by a content server 132, may wish to track exposure data for the articles on its website. Accordingly, the provider will employ an exposure tracking server (e.g., exposure tracking server 120) in order to collect tracking data from visitors to the website. In this case, the exposure tracking server 120 and the content server 132 associated with the media content provider can be combined into one server, or can be implemented as two (or more) different servers.

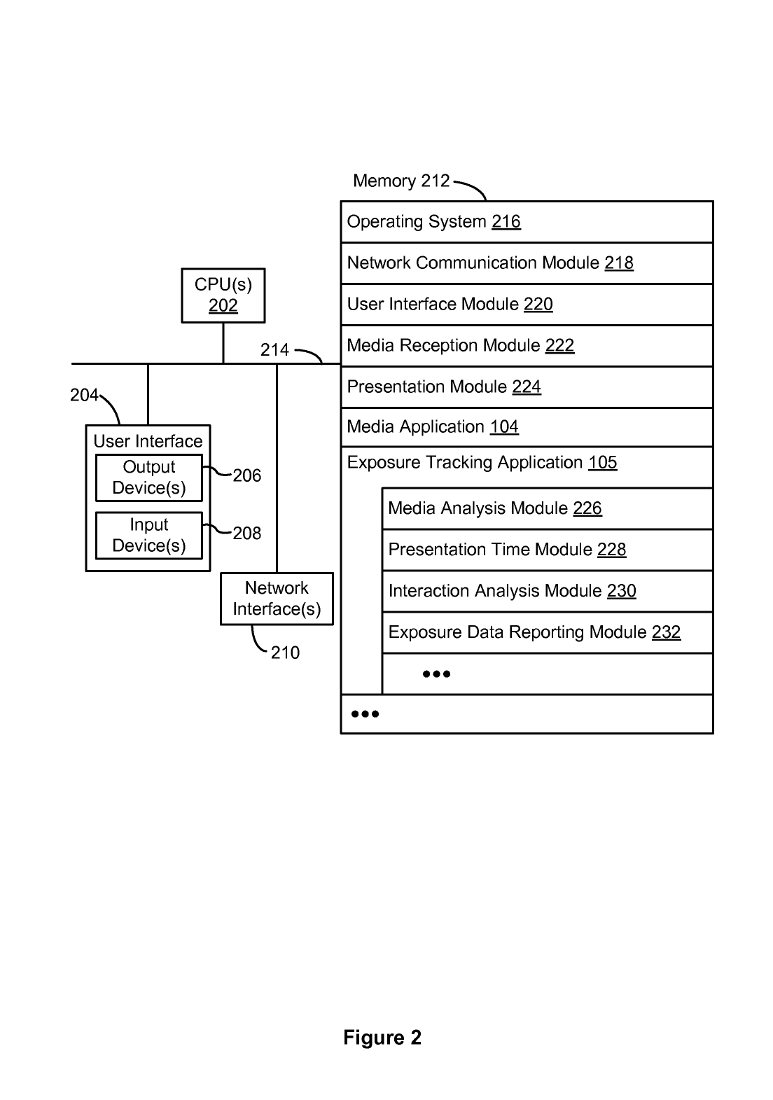

FIG. 2 is a block diagram illustrating a representative client device 110 (e.g., client device 110-1) in accordance with some implementations. The client device 110-1, typically, includes one or more processing units/cores (CPUs) 202, one or more network interfaces 210, memory 212, and one or more communication buses 214 for interconnecting these components. The client device 110-1 includes (or is configured to be connected to) a user interface 204. The user interface 204 includes one or more output devices 206, including user interface elements that enable the presentation of media content to a user, including via speakers or a display. The user interface 204 also includes one or more input devices 208, including user interface components that facilitate user input such as a keyboard, a mouse, a remote control, a voice-command input unit, a touch-sensitive display (sometimes also herein called a touch screen display), a touch-sensitive input pad, a gesture capturing camera, or other input buttons. In some implementations, the client device 110-1 is a wireless device, such as a mobile phone or a tablet computer. Furthermore, in some implementations, the client device 110-1 uses a microphone and voice recognition or a camera and gesture recognition to supplement or replace the keyboard.

Memory 212 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. Memory 212, optionally, includes one or more storage devices remotely located from one or more CPUs 202. Memory 212, or, alternatively, the non-volatile memory device(s) within memory 212, includes a non-transitory computer readable storage medium. In some implementations, memory 212, or the computer readable storage medium of memory 212, stores the following programs, modules, and data structures, or a subset or superset thereof:
an operating system 216 that includes procedures for handling various basic system services and for performing hardware dependent tasks;
a network communication module 218 for connecting the client device 110-1 to other computing devices via the one or more communication network interfaces 210 (wired or wireless) connected to one or more networks 115 such as the Internet, other Wide Area Networks, Local Area Networks, Personal Area Networks, metropolitan area networks, VPNs, peer-to-peer, content delivery networks, ad-hoc connections, and so on;
a user interface module 220 that receives commands and/or inputs from a user via the user interface 204 (e.g., from the input device(s) 208, which may include keyboard(s), touch screen(s), microphone(s), pointing device(s), eye tracking components, three-dimensional gesture tracking components, and the like), and provides user interface objects and other outputs for display on the user interface 204 (e.g., the output device(s) 206, which may include a computer display, a television screen, a touchscreen, etc.);
a media reception module 222 for receiving media content (e.g., media content streams, media content files, advertisements, webpages, videos, audio, games, etc.) from a content server 132;
a presentation module 224 (e.g., a media player, web browser, content decoder/renderer, e-book reader, gaming or other application, etc.) for enabling presentation of media content at the client device 110-1 (e.g., rendering media content) through output device(s) 206 associated with the user interface 204;
a media application 104 for processing media content (e.g., media content streams, media content files, advertisements, webpages, videos, audio, games, etc.), for providing processed media content to the presentation module 224 for transmittal to the one or more output device(s) 206, and for providing controls enabling a user to navigate, select for playback, and otherwise control or interact with media content; and
an exposure tracking application 105 for tracking exposure data at the client device 110-1, including detecting user input events (e.g., from one or more of the input device(s) 208), determining exposure times (e.g., a length of time that content is displayed), and, optionally, generating media metrics from the exposure data; in some implementations the exposure tracking application 105 includes:
   a media analysis module 226 for analyzing media content items that are presented by the client device 110-1, including dividing the media content items into segments for independent exposure tracking;
   a presentation time module 228 for measuring and/or recording the durations that media content items, or segments thereof, are presented to a user;
   an interaction analysis module 230 for measuring and/or recording user interactions with (or contemporaneous to) presentation of media content items, including, but not limited to, cursor positions, cursor movements, scroll rate, scroll speed, content navigation selections (e.g., skip forward, skip backward, pause, stop, etc.), eye movements/positions, touch events (e.g., touch locations, gesture types, etc.), and the like; and
   an exposure data reporting module 232 for preparing and reporting exposure data to a remote device (e.g., the exposure tracking server 120, FIG. 1).

Each of the above identified elements may be stored in one or more of the previously mentioned memory devices, and corresponds to a set of instructions for performing a function described herein. The above identified modules or programs (i.e., sets of instructions) need not be implemented as separate software programs, procedures, or modules, and thus various subsets of these modules may be combined or otherwise re-arranged in various implementations. In some implementations, memory 212, optionally, stores a subset of the modules and data structures identified above. Furthermore, memory 212, optionally, stores additional modules and data structures not described above.

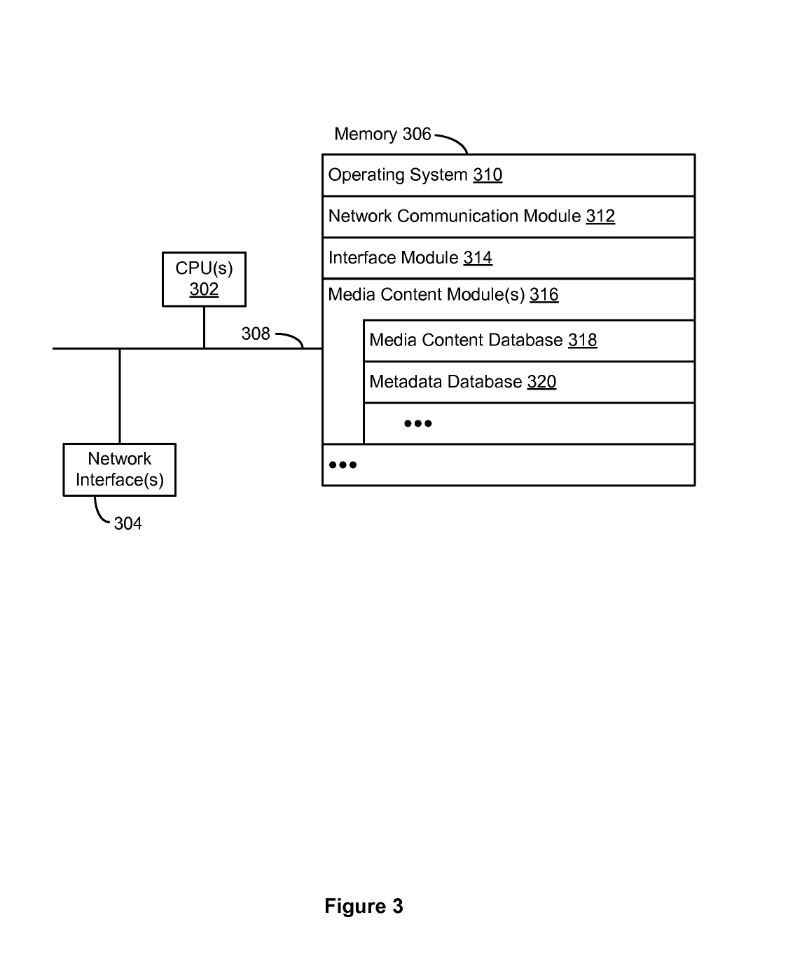

FIG. 3 is a block diagram illustrating a representative content server 132 (e.g., content server 132-1) in accordance with some implementations. The content server 132-1, typically, includes one or more processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. Memory 306, optionally, includes one or more storage devices remotely located from one or more CPUs 302. Memory 306, or, alternatively, the non-volatile memory device(s) within memory 306, includes a non-transitory computer readable storage medium. In some implementations, memory 306, or the computer readable storage medium of memory 306, stores the following programs, modules and data structures, or a subset or superset thereof:
an operating system 310 that includes procedures for handling various basic system services and for performing hardware dependent tasks;
a network communication module 312 that is used for connecting the content server 132-1 to other computing devices via one or more communication network interfaces 304 (wired or wireless) connected to one or more networks 115 such as the Internet, other Wide Area Networks, Local Area Networks, Personal Area Networks, metropolitan area networks, VPNs, peer-to-peer, content delivery networks, ad-hoc connections, and so on;
an interface module 314 for sending (e.g., streaming) media content to and receiving information from a client device (e.g., the client device 110-1) remote from the sever system 132-1; in various implementations, information received from the client device includes requests from client devices for media content (e.g., requests to download or stream media content, http or https requests, etc.); and
one or more media content module(s) 316 for handling the storage of and access to media content items and metadata relating to the media content items; in some implementations the one or more media content module(s) 316 include:
   a media content database 318 for storing media content items (e.g., webpages, advertisements, audio content, video content, games, interactive content, etc.); and
   a metadata database 320 for storing metadata relating to the media content items, the metadata including, for example, information identifying segments of media content items for which exposure data is to be individually tracked (e.g., segment start/stop times, segment beginning/end text locations, etc.).

Each of the above identified elements may be stored in one or more of the previously mentioned memory devices, and corresponds to a set of instructions for performing a function described herein. The above identified modules or programs (i.e., sets of instructions) need not be implemented as separate software programs, procedures, or modules, and thus various subsets of these modules may be combined or otherwise re-arranged in various implementations. In some implementations, memory 306, optionally, stores a subset or superset of the modules and data structures identified above. Furthermore, memory 306, optionally, stores additional modules and data structures not described above.

Although FIG. 3 shows the content server 132-1, FIG. 3 is intended more as a functional description of the various features that may be present in one or more servers than as a structural schematic of the implementations described herein. In practice, and as recognized by those of ordinary skill in the art, items shown separately could be combined and some items could be separated. For example, some items shown separately in FIG. 3 could be implemented on a single server and single items could be implemented by one or more servers. The actual number of servers used to implement the content server 132-1, and how features are allocated among them, will vary from one implementation to another and, optionally, depends in part on the amount of data traffic that the system must handle during peak usage periods as well as during average usage periods.

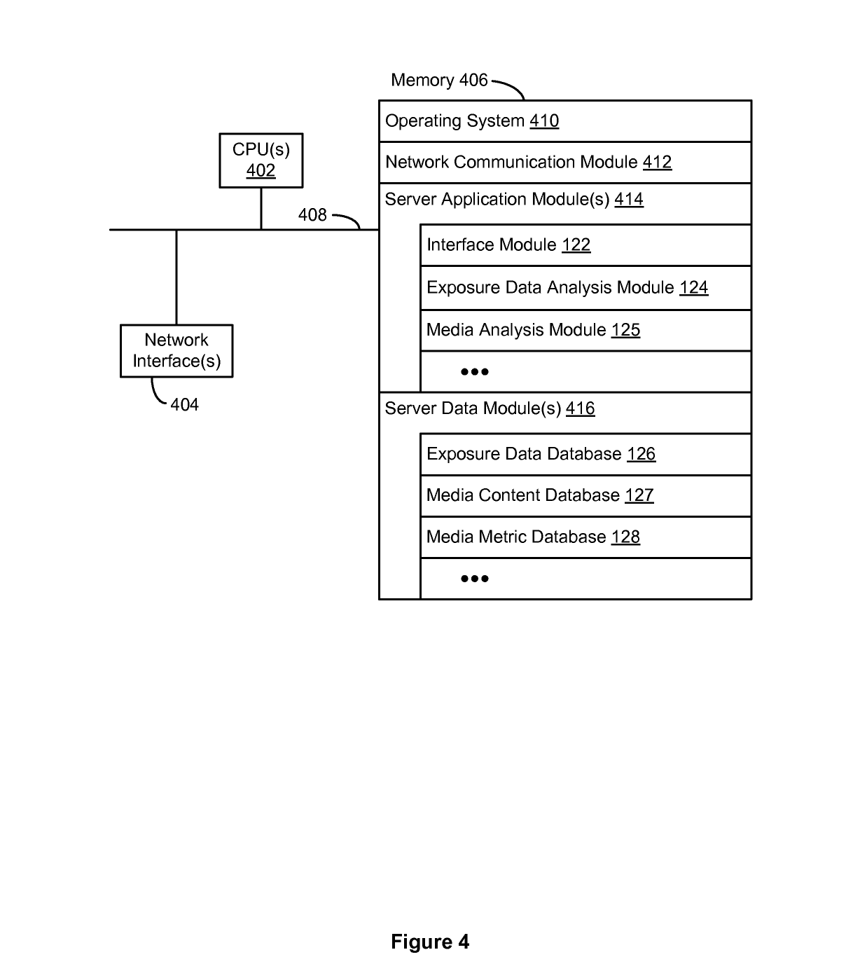

FIG. 4 is a block diagram illustrating an exposure tracking server 120 in accordance with some implementations. The exposure tracking server 120, typically, includes one or more processing units/cores (CPUs) 402, one or more network interfaces 404, memory 406, and one or more communication buses 408 for interconnecting these components.

Memory 406 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. Memory 406, optionally, includes one or more storage devices remotely located from one or more CPUs 402. Memory 406, or, alternatively, the non-volatile memory device(s) within memory 406, includes a non-transitory computer readable storage medium. In some implementations, memory 406, or the computer readable storage medium of memory 406, stores the following programs, modules and data structures, or a subset or superset thereof:
an operating system 410 that includes procedures for handling various basic system services and for performing hardware dependent tasks;
a network communication module 412 that is used for connecting the exposure tracking server 120 to other computing devices via one or more communication network interfaces 404 (wired or wireless) connected to one or more networks 115 such as the Internet, other Wide Area Networks, Local Area Networks, Personal Area Networks, metropolitan area networks, VPNs, peer-to-peer, content delivery networks, ad-hoc connections, and so on;
one or more server application modules 414 for enabling the exposure tracking server 120 to perform various functionalities, the server application modules 414 including, but not limited to, one or more of:
   an interface module 122 for receiving information from one or more client devices (e.g., client devices 110-n) and/or one or more content servers (e.g., content servers 130-n), and storing the received information in a database (e.g., the exposure data database 126, the media content database 127, and/or the media metric database 128); in various implementations, information received from a client device includes:
      exposure data, including, but not limited to, durations of presentation, durations of interaction, cursor positions, cursor movements, scroll rate, scroll speed, content navigation selections (e.g., skip forward, skip backward, pause, stop, etc.), eye movements/positions, touch events (e.g., touch locations, gesture types, etc.), and the like;
      engagement metrics, including, but not limited to, any metric derived or calculated from any of the foregoing exposure data (as well as other exposure data not listed); and
      user information, including, but not limited to, user demographics (e.g., age, sex, location, etc.), user interest information (e.g., content preferences, purchase histories, download histories, media access histories, self-reported or derived interests, social group affiliations, likes, dislikes, etc.), and the like;
   an exposure data analysis module 124 for receiving and/or accessing media exposure data received from one or more client devices (e.g., from the exposure data database 126), user information, and media content information, for generating media engagement metrics from the exposure data, user information, and media content information, and for generating reports based on the foregoing information;
   a media analysis module 125 for analyzing media content items that are to be tracked, including dividing the media content items into segments for independent exposure tracking; and
one or more server data modules 430 for storing data related to the exposure tracking server 120, including but not limited to:
   an exposure data database 126 for storing exposure data received from one or more client devices, the exposure data including, but not limited to, durations of presentation, durations of interaction, cursor positions, cursor movements, scroll rate, scroll speed, content navigation selections (e.g., skip forward, skip backward, pause, stop, etc.), eye movements/positions, touch events (e.g., touch locations, gesture types, etc.), and the like, where the exposure data is stored in association with user information, including, but not limited to, user identifiers, user profiles, user demographics (e.g., age, sex, location, etc.), user interest information (e.g., content preferences, purchase histories, download histories, media access histories, self-reported or derived interests, social group affiliations, likes, dislikes, etc.), and the like;
   a media content database 127 for storing media content items (e.g., webpages, advertisements, audio content, video content, games, interactive content, etc.), and metadata relating to the media content items, the metadata including, but not limited to, information identifying segments of media content items for which exposure data is to be individually tracked (e.g., segment start/stop times, segment beginning/end text locations, etc.); and
   a media metric database 128 for storing media metrics derived or calculated from exposure data (e.g., engagement metrics).

Each of the above identified elements may be stored in one or more of the previously mentioned memory devices, and corresponds to a set of instructions for performing a function described herein. The above identified modules or programs (i.e., sets of instructions) need not be implemented as separate software programs, procedures, or modules, and thus various subsets of these modules may be combined or otherwise re-arranged in various implementations. In some implementations, memory 406, optionally, stores a subset or superset of the modules and data structures identified above. Furthermore, memory 406, optionally, stores additional modules and data structures not described above.

Although FIG. 4 shows the exposure tracking server 120, FIG. 4 is intended more as a functional description of the various features that may be present in one or more servers than as a structural schematic of the implementations described herein. In practice, and as recognized by those of ordinary skill in the art, items shown separately could be combined and some items could be separated. For example, some items shown separately in FIG. 4 could be implemented on single servers and single items could be implemented by one or more servers. The actual number of servers used to implement the exposure tracking server 120, and how features are allocated among them, will vary from one implementation to another and, optionally, depends in part on the amount of data traffic that the system must handle during peak usage periods as well as during average usage periods.

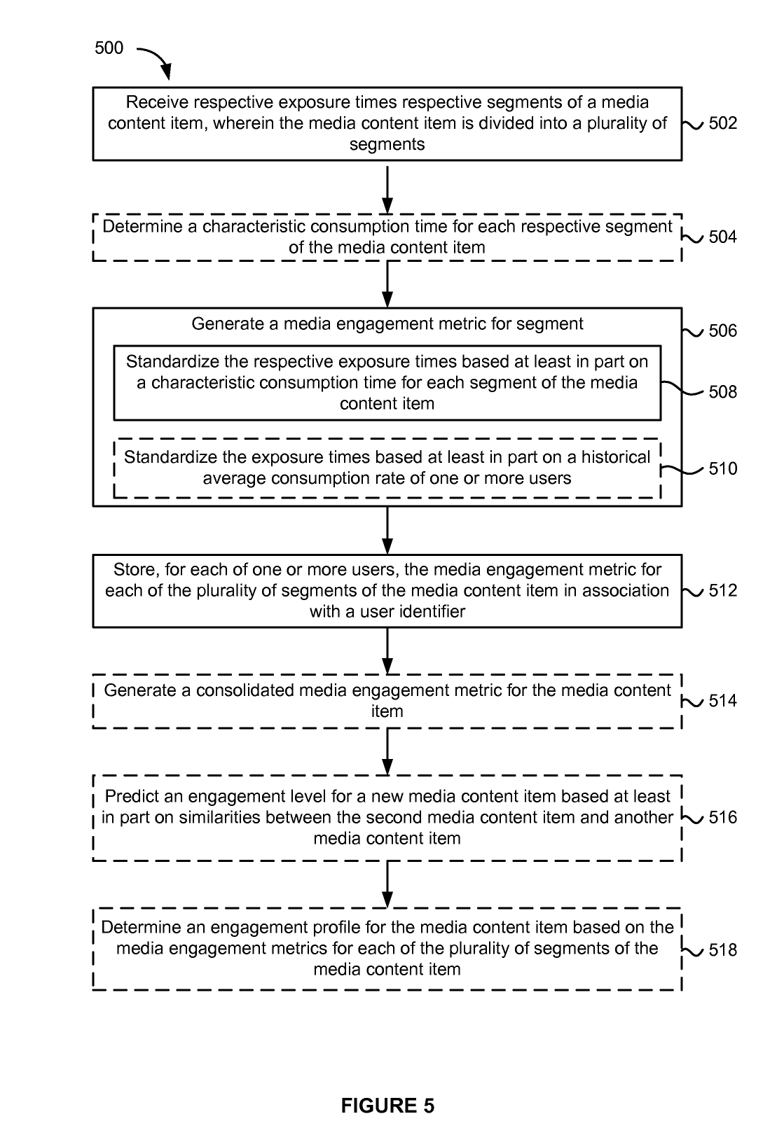

FIG. 5 is a flow diagram illustrating a method 500 for determining a media engagement metric for a media content item, in accordance with some implementations. The method 500 is performed at an electronic device (e.g., the exposure tracking server 120, as shown in FIGS. 1 and 3). While the following discussion describes an implementation where the exposure tracking server 120 performs the steps of the method 500, in other implementations, one or more of the steps are performed by another electronic device, such as a client device 110-n. Moreover, some operations in method 500 are, optionally, combined and/or the order of some operations is, optionally, changed.

Furthermore, while the method 500 describes determining a media engagement metric for a single media content item, the same or similar technique is also intended for application to multiple media content items.

The exposure tracking server 120 receives, from each of one or more users, respective exposure times for one or more respective segments of a media content item, wherein the media content item is divided into a plurality of respective segments (502). In some implementations, the exposure tracking server 120 stores the exposure times in a database (e.g., the exposure data database 126) in association with user identifiers corresponding to the measured exposure times.

Ideally, exposure times correspond to the amount of time that a user is actively engaged with a content item, such as the amount of time a user is reading a piece of text, listening to audio, watching a video, playing a game, or the like. Because it is not always practical to measure the engagement time directly, indirect measurements can be used as heuristics for actual engagement time. For example, exposure time for a segment that includes textual content corresponds to an amount of time that the segment was actually displayed to a user. As another example, exposure time for a segment that includes audio content corresponds to an amount of time that the audio was actually being played back. For video content, exposure time corresponds to an amount of time that the video was being played back and was actually displayed to the user (e.g., was not obstructed by another application or window, etc.). (Whether a video player is actually being displayed to a user may be identified by a state of an operating system or user interface property, such as a property that identifies what window or application is currently in the foreground or is the current focus of the user interface, or a property of a window or application that identifies whether that window or application is currently in the foreground or is the current focus of the user interface.) For interactive content (e.g., games), exposure time corresponds to an amount of time that the user was actively playing the game, as determined by user inputs and/or gameplay statistics.

As noted above, exposure times are associated with particular segments of a media content item. For example, a webpage may be divided into multiple segments, and exposure times for each segment of the webpage are recorded independently. Segments are defined in any appropriate manner based on the particular type of media content and preferences of the content provider (or exposure tracking entity). For example, text content is divided into respective textual segments, each segment based on an appropriate number of: words, sentences, paragraphs, pages, sections, or subject matter. Textual segments may also be arbitrarily defined. Audio and video content is divided into audio or video segments based on time (e.g., 1, 2, 3, 4, 5 minute segments, or any other appropriate time), subject matter (e.g., chapters, scenes, tracks, etc.), or the like. Graphical content is divided into segments based on appropriate numbers of graphics (e.g., 1, 2, 5, or 10 images, or any other appropriate number). Interactive content is divided into segments based on time, gameplay segments (e.g., levels, arenas, rooms, etc.), or the like. Other types of content are divided into segments using any appropriate technique.

In some implementations, segment boundaries are embedded in or otherwise linked to content items. For example, a content provider (or another entity that wants to track exposure to a particular content item) identifies segments of media content items and embeds markers that identify those segments into the content items. An exposure tracking application (e.g., exposure tracking application 105) or an exposure tracking server (e.g., exposure tracking server 120) identifies the segments based on the markers and tracks exposure to the predefined segments.

In some implementations, instead of or in addition to embedding the markers into the content items (e.g., as HTML elements, embedded codes/signals, or the like), the segment boundaries are provided in metadata associated with the content items (e.g., in a header file, an associated but distinct metadata file, an ID3 tag, etc.).

In some implementations, segment boundaries are determined on-the-fly by an exposure tracking application (e.g., exposure tracking application 105) or an exposure tracking server (e.g., exposure tracking server 120). For example, the exposure tracking application 105 on a client device 110-1 will determine that a user is viewing a content item, and will analyze the content item to identify appropriate segment boundaries. As a specific example, the exposure tracking application 105 (which may be a browser plugin, for example) will scan or otherwise process the webpages that are displayed in a web browser to identify segment boundaries. The segment boundaries are identified using any appropriate rules, as described above (e.g., paragraph boundaries, section boundaries, audio tracks, video chapters, etc.). Segment boundaries may be identified based on properties of the content item (e.g., carriage returns, line breaks, html tags (e.g., <br>; <p>, etc.), and the like), or by tags that are included/embedded in the content item specifically for identifying segment boundaries for the purposes of media exposure tracking.

Returning to FIG. 5, in some implementations, the exposure tracking server 120 determines a characteristic consumption time for each respective segment of the media content item (504). The characteristic consumption time for a respective segment of the media content item is based at least in part on a length of the respective segment and an information density of the respective segment, and corresponds to an estimate of the amount of time it would take a hypothetical user to completely consume the respective segment (i.e., read, view, hear, or interact with the content long enough to be able to comprehend the content). In particular, the amount of time that it would take a hypothetical user to completely consume a segment of text depends on various factors, including the length of the segment, how difficult the segment is to comprehend, and the ability of the user (i.e., the user's average reading rate, familiarity with the subject matter, intelligence, etc.). The length of the segment can be determined by examining the content itself—for text, for example, the length corresponds to a number of words of the segment. For video and audio content, the length corresponds to a length of the video or audio segment.

The difficulty of the segment is based on the information density of the segment (i.e., a measure of how difficult the segment is to comprehend and/or how much information is contained in the segment), which is based on one or more properties of the segment. For example, in some implementations, the information density of a segment is based on properties selected from the group consisting of: a number of concepts in the segment; a difficulty of concepts in the segments (e.g., astrophysics will be more difficult to comprehend, for most people, than celebrity gossip); complexity of sentence structure; complexity of vocabulary; a measured reading level (e.g., Flesch reading ease or Flesch-Kincaid grade level); a number of scenes in a segment; and complexity of dialogue in a segment.

In some implementations, the information density and/or difficulty of the segment is performed by human analysis. For example, one or more reviewers may analyze content items and assign an information density to segments based on a predetermined scale or rule set. Such a process may be undertaken by an exposure tracking entity and/or by content creators/providers.

In some implementations, the information density and/or difficulty of the segment is performed automatically or semi-automatically. For example, information density of textual content may be determined based on semantic and/or syntactic analysis of the text. In some cases, the analysis determines metrics such as subject matter, complexity of vocabulary, estimated “grade level” of the text, and the like. In some implementations, one or more statistical classifiers are used to determine these metrics, and/or other metrics not listed.

Basing the characteristic consumption time, at least in part, on the information densities of segments standardizes the characteristic consumption times of different segments, thus enabling comparison of media engagement metrics between segments of varying difficulty. For example, if the characteristic consumption time were only based on the length of the content and an average consumption rate (e.g., reading rate), then two webpages of the same size would have the same characteristic consumption time, even though one might relate to astrophysics and the other to celebrity gossip. Thus, an exposure time of five minutes for each of these webpages would result in identical measures of user engagement, even though five minutes may be insufficient for most people to actually comprehend the content of the webpage on astrophysics. When the characteristic consumption time takes information density into consideration, however, a detected exposure to the celebrity gossip webpage of five minutes may result in a determination that the user completely consumed the webpage, whereas a 30 minute exposure to the astrophysics webpage will result in a determination of complete consumption. Thus, even though the exposure times are dramatically different, the resulting media metric will reflect that a user engaged with both content items equally.

For content items that have a fixed time base, such as video and audio, characteristic length is, in some implementations, the length of the segment (e.g., a 1 minute segment has a characteristic length of 1 minute). However, different information densities will result in different characteristic consumption times even for these types of content. For example, a video or audio content item may have so much information or be so difficult to understand that most people will have to repeat (or pause or rewind) the content in order to fully perceive and comprehend the content, thus resulting in a characteristic consumption time that is longer than the segment duration. On the other hand, the audio or video content may have extended periods of silence or uninteresting content (e.g., introductions, credits, theme songs, commercials, etc.), that most people would be likely to skip portions of the content, thus resulting in a characteristic consumption time that is shorter than the segment duration. Accordingly, in some implementations, the information density of audio or video content is determined by considering factors selected from the group consisting of: an amount of dialog in the segment (e.g., how many words are spoken); complexity of dialogue in the segment (e.g., complexity of vocabulary, subject matter, number of speakers, etc.); an amount of action in the segment (e.g., whether the segment includes a car chase, a fight scene, etc.); and the location of the segment in the video (e.g., whether the segment is near a beginning, end, or middle of a larger content item, etc.).

In some implementations, the information density and/or difficulty of the audio or video content is performed by human analysis. For example, as described above, one or more reviewers may analyze content items and assign an information density to segments based on a predetermined scale or rule set. Such a process may be undertaken by an exposure tracking entity and/or by content creators/providers.

In some implementations, the information density and/or difficulty of the audio or video content is performed automatically or semi-automatically. For example, information density of video or audio content may be determined based on semantic and/or syntactic analysis of speech content within the audio or video. Speech content is obtained for audio or video content using any appropriate technique, such as by extracting the speech content using a speech-to-text analyzer, or by obtaining a script or transcript of the speech content. In some cases, the analysis determines metrics such as subject matter, complexity of vocabulary, estimated “grade level” of the speech content, and the like. In some implementations, one or more statistical classifiers are used to determine these metrics, and/or other metrics not listed.

For graphical content (e.g., a photograph), the information density is based at least in part on the complexity of the graphical content, such as how many subjects the graphic contains, how many colors it contains, how large the graphic is, whether the graphic is a photograph, whether the graphic is a cartoon/drawing, and the like.

In some implementations, the information density and/or difficulty of the graphical content is performed by human analysis. For example, as described above, one or more reviewers may analyze content items and assign an information density to graphics/images/photographs based on a predetermined scale or rule set. Such a process may be undertaken by an exposure tracking entity and/or by content creators/providers.

In some implementations, the information density and/or difficulty of the graphical content is performed automatically or semi-automatically. For example, information density of graphical content may be determined based on a computer analysis of the graphical content (e.g., to determine the number of colors in the graphical content, a size of the content, an amount of detail in the graphical content, etc). In some implementations, one or more statistical classifiers are used to determine these metrics, and/or other metrics not listed.

As noted above, the characteristic consumption time also takes into consideration the speed with which a hypothetical user would consume the segment of content. In some implementations, this speed is based on an average consumption rate (e.g., a historical average consumption rate for all content of a similar medium, or an average reading rate for a group of people). For example, for textual content, the characteristic consumption time can be determined using the average expected reading rate for consumers of that media (e.g., all users, users of a certain age range, etc.).

Returning to FIG. 5, the exposure tracking server 120 generates, for each user of the one or more users, a media engagement metric for each of the plurality of segments of the media content item (506). Generating the media engagement metric includes standardizing the respective exposure times based at least in part on a characteristic consumption time for each respective segment of the media content item (508). Techniques for determining a characteristic consumption time for segments of the media content item are described above with reference to step (504).

In some implementations, the media engagement metric is a number that correlates to the degree to which a user has engaged with or consumed a media content item. For example, in some implementations, a formula (1) for generating a media engagement metric M takes the form:

M=(Dₑ/Tₑ)*100 (1)

where Dₑ is the duration that a user is exposed to the content item and T_{c} is the characteristic consumption time. Thus, for a segment with a characteristic consumption time of 60 seconds, a measured exposure time of 42 seconds corresponds to a media engagement metric of 70%.

Formula (1) for generating a media engagement metric is merely exemplary, and other formulas may also be used without departing from the spirit of the invention. Moreover, other formulas for determining the media engagement metric may include more or different factors for generating the engagement metric, such as other information that indicates a level of user engagement with media content. Indeed, the concepts described with respect to method 500 for generating a characteristic consumption time also apply to media engagement data other than exposure time. For example, instead of or in addition to generating a characteristic consumption time, the exposure tracking server 120 can generate a characteristic mouse activity value for segments of media content items, where the characteristic mouse activity corresponds to an expected amount of mouse activity necessary for (or representative of) complete consumption of the segments. Measured mouse activity from users is then used to generate media engagement metrics for the content items in light of the characteristic mouse activity. As in the case for media engagement metrics that are standardized based on a characteristic consumption time, media engagement metrics that are standardized based on mouse activity (or any other measure of user engagement or interaction) can be compared to one another in a meaningful way.

In some implementations, generating the media engagement (506) metric further includes standardizing the respective exposure times based at least in part on a historical average consumption rate of the one or more users (510). Standardizing exposure times based on historical average consumption rates provides even greater insight into actual media engagement by correcting for differences in how different populations or groups of users consume content. Specifically, some users (or groups of users) will tend to consume content faster than others. Thus, when comparing exposure times of different users (or different groups of users), the same raw exposure time for one user may reflect a very different degree of consumption or engagement than an identical exposure time for another user. For example, a user with a high reading rate and comprehension ability may spend considerably less time engaging with content than a person with an average reading rate and comprehension ability. Comparing these users' raw exposure times for a respective content segment would likely result in a conclusion that the former user engaged with the content to a lesser degree than the latter user, even though they likely had the same level of engagement. Thus, exposure times can be further standardized based on differences between individual users (or groups of users) so that more effective comparisons can be made between media engagement metrics of different users.

In some implementations, standardizing media engagement metrics based on historical average consumption rates for one or more users is performed in response to a request for particular media engagement metrics. For example, media engagement metrics are standardized in this manner when a specific report or set of data is requested. As a specific example, in response to a request for a report comparing engagement metrics for a particular content item between two different groups, the exposure tracking server 120 adjusts the media engagement metrics for each group based on a historical average consumption rate for each group. Thus, it will be possible to effectively compare levels of engagement between two groups that have different engagement habits.

One exemplary group for which media engagement metrics are standardized based on historical average consumption rates is a group of all users that were exposed to a particular content item. Thus, in response to a request for an overall engagement metric for a content item, the media tracking server 120 adjusts the engagement metrics of the group based on the difference between the average consumption rate of all users and the average consumption rate of users that were exposed to the media content. This metric can then be compared against an overall engagement metric for a different media content item, regardless of the differing content consumption habits of the different groups of users from which the engagement metrics were derived.

Another exemplary group for which media engagement metrics are standardized based on historical average consumption rates are users having a common psychographic group. A psychographic group is a group of users that share a similar set of values, attitudes, interests, or lifestyles. Psychographic groups can be identified based on self-reported psychographic affiliations (e.g., where users fill out a questionnaire or survey in which they self-report group affiliations, such as “hipster,” “fashionista,” “environmentalist”, and the like), or based on a definition composed of user interests and/or other information from user profiles. For example, a definition of a psychographic group may be “all users in the age range 18-25 who listen to indie music and like exotic foods.”

Yet another exemplary group for which media engagement metrics are standardized based on historical average consumption rates are users having a common age range.

Finally, as noted above, media engagement metrics can be further standardized based on historical average consumption rates of individual users. Thus, if a content provider wants to evaluate how two different users engaged with a segment of media content, the exposure tracking server 120 will adjust the media engagement metrics for each individual user based on the historical average consumption rate for the individual user. Once again, this allows effective comparison between the two users, even though they may have drastically different consumption habits that would otherwise render a comparison meaningless.

In some implementations, historical average consumption rates for users (or groups of users) is based on previously stored media exposure data for those users. Specifically, the exposure tracking server 120 maintains an exposure data database 126 and a media metric database 128, where media exposure data and media metrics are stored in association identifiers of the users from which the exposure data was received. When a request is received for a report showing media engagement metrics for particular users or groups of users, the exposure data analysis module 124 identifies historical average consumption rates for the requested groups and adjusts the media engagement metrics prior to providing them to the requestor (e.g., in the report). This way, standardization based on historical average consumption rates can be applied to any group that is selected. In particular, groups of users can be defined based on any user information stored in the exposure data database 126 or the media metric database 128, including user profile information, demographic information, and the like. Thus, many different groups can be identified based on many different combinations of user information. For example, an advertiser may want to compare engagement metrics for an advertisement between “baby boomers” and men aged 18-25 who have a post-college education and live in the Pacific Northwest. In response to receiving this request, the exposure tracking server 120 will calculate a historical average consumption rate for each group and adjust the media engagement metrics for each group so that a fair comparison can be made. While historical averages can be generated at any time, it is useful to be able to generate them in response to a specific request, as it may be difficult to predict and store all combinations of user characteristics that a content provider or content creator will want to use to define a group of users.

The exposure tracking server 120 then stores (e.g., in the media metric database 128), for each of the one or more users, the media engagement metric for each of the plurality of segments of the media content item in association with a user identifier (512). In some implementations, the engagement metrics are stored without first standardizing them based on historical average consumption rates. The engagement metrics are then adjusted based on historical average consumption in response to receiving a specific request, as described above.

In some implementations, once an engagement metric is standardized based on a historical average consumption rate, the resulting media engagement is stored (e.g., in the media metric database 128). Thus, if that particular media engagement metric is requested at a later time, it can be retrieved without having to recalculate the metric based on the historical average consumption rates of the requested user or group of users.

In some implementations, the exposure tracking server 120 generates a consolidated media engagement metric for the media content item based at least in part on the media engagement metrics for each of the plurality of segments of the media content item (514). In some implementations, the consolidated media engagement metric is an average of the media engagement metrics for each segment (or a subset of segments) of the media content item.

In some implementations, the exposure tracking server 120 predicts an engagement level for a new media content item based at least in part on similarities between the second media content item and another media content item (516). Thus, a content provider can request, from the exposure tracking server 120, a media engagement prediction for a content item having a particular set of properties and/or characteristics. The exposure tracking server 120 (e.g., with the exposure data analysis module 124) identifies some or all media engagement metrics for media content items having the same or similar properties and/or characteristics, and determines, based on the stored media engagement metrics for those media content items, a predicted media engagement metric for the new media content item. In some implementations, the predicted media engagement metric is an average (e.g., a mean, median, or mode) of the stored engagement metrics relating to similar content. Exemplary properties of the media content items that can be used to identify similarities between content items include media type(s) (e.g., video, text, graphic, interactive, combined, etc.), content tones/styles (e.g., satirical, humorous, serious, etc.), content genre (e.g., news, advertisement, television show, movie, general interest, etc.), and the like. As a specific example, a content provider or content creator can request a prediction for how well a satirical video relating to current political events will be received by a group of “baby boomers.” The exposure tracking server 120 (e.g., with the exposure data analysis module 124) then identifies other media content items having the same or similar characteristics (e.g., satirical videos relating to current political events), and retrieves historical media engagement metrics for that content for all “baby boomers.” The exposure tracking server 120 then predicts, based on the historical media engagement metrics, how well the new content item will fare with “baby boomers.”

In some implementations, predicted engagement metrics are based on trends that are detectable in historical data for similar content items. In particular, if it is detected from historical media engagement metrics that satirical videos are becoming more popular with a certain user or group of users, then the predicted engagement metric for the new content item may be higher than a historical average engagement metric for similar content. Specifically, in the foregoing example, a historical average engagement metric may include older engagement metrics that are uncharacteristically low based on current opinions and habits, which would tend to lower an average engagement metric, which would be contrary to the current trends. Accordingly, historical trend information is used in some implementations to provide more accurate predictions.

Furthermore, it may not be possible or practical in all circumstances to predict an engagement metric based on content with identical characteristics and properties. For example, it may be desired to predict an engagement metric for a satirical video relating to a particular current event where there is no media exposure data for satirical videos relating to that particular event. Thus, in some implementations, predicted engagement metrics for a new content item are based on historical data of two or more historical content items, where each historical content item has some aspect in common with the new content item. Returning to the preceding example, a predicted media engagement metric for a satirical video relating to a particular current event may be based, in part, on satirical text content related to the particular current event and satirical videos related to other current events.

In some implementations, the predicted media engagement metric is based on a combination of the historical media engagement metrics for these historical content items (e.g., a mean, median, or mode). For example, the predicted media engagement metric may be based on a weighted average of the historical content items, where each historical content item that is used to generate the prediction is weighted based on an importance of the characteristics and/or properties for which it is selected. More specifically, in some implementations, the subject matter of the content item will be a better predictor of its reception among users than the content type (e.g., whether the content is video or text). Thus, the average media engagement metric for a historical content item that relates to the same or a similar subject matter as the new content item may be given more weight than a historical content item that is of the same content type. In some implementations, a formula (2) for generating a predicted media engagement metric Mₚ takes the form:

Mₚ=((W₁*M_{avg 1})+(W₂*M_{avg 2})+(W₃*M_{avg 3})+ . . . +(Wₙ*M_{avg n}))/n (2)

where M_{avg n} is the average media engagement metric for a content item n having one or more characteristics in common with the new media content item, and Wₙ is the weighting to be applied to the content item n in based on the relative importance of the one or more characteristics for which the content item n is included in the prediction. Weighting values may be determined based on any appropriate information, such as historical information relating to how strongly a particular characteristic or property of a media content item tends to suggest or predict the engagement metric of other content items having the same characteristic or property. Formula (2) for generating a predicted media engagement metric is merely exemplary, and other formulas may also be used without departing from the spirit of the invention.

In some implementations, the exposure tracking server determines an engagement profile for the media content item based on the media engagement metrics for each of the plurality of segments of the media content item (518). An engagement profile describes how user engagement with media content varies among the various segments of the media content item (e.g., whether user interest increases, decreases, or stays consistent throughout the various segments of the content item). For example, if media engagement metrics increase from the first segment to the last segment (i.e., an increasing engagement profile), a content provider or creator can determine that user interest tends to increase as the user gets more invested in the content item. On the other hand, if the media engagement metrics decrease from the first segment to the last segment, then the content provider or creator can determine that user interest tends to fade as they get further into the content item. Such information can then be used by content providers or creators in order to adjust content selections, styles, or types in order to achieve better user engagement with its content.

It should be understood that the particular order in which the operations in FIG. 5 have been described is merely exemplary and is not intended to indicate that the described order is the only order in which the operations could be performed. One of ordinary skill in the art would recognize various ways to reorder the operations described herein. For brevity, these details are not repeated here.

Plural instances are, optionally provided for components, operations, or structures described herein as a single instance. Finally, boundaries between various components, operations, and data stores are somewhat arbitrary, and particular operations are illustrated in the context of specific illustrative configurations. Other allocations of functionality are envisioned and optionally fall within the scope of the implementation(s). In general, structures and functionality presented as separate components in the example configurations are, optionally, implemented as a combined structure or component. Similarly, structures and functionality presented as a single component are, optionally, implemented as separate components. These and other variations, modifications, additions, and improvements fall within the scope of the implementation(s).

It will also be understood that, although the terms “first,” “second,” are, in some circumstances, used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” is, optionally, construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter is, optionally, practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method for determining a media engagement metric for a media content item, performed at a server computer system having one or more processors and memory storing one or more programs for execution by the one or more processors, the method comprising:
receiving, from each of one or more users, respective exposure times for one or more respective segments of a media content item, wherein the media content item is divided into a plurality of respective segments;
generating, for each user of the one or more users, a media engagement metric for each of the plurality of segments of the media content item, wherein generating the media engagement metric includes standardizing the respective exposure times based at least in part on a characteristic consumption time for each respective segment of the media content item; and
storing, for each of the one or more users, the media engagement metric for each of the plurality of segments of the media content item in association with a user identifier.

2. The method of claim 1, further comprising determining the characteristic consumption time for each respective segment of the media content item, wherein the characteristic consumption time for a respective segment of the media content item is based at least in part on a length of the respective segment and an information density of the respective segment.

3. The method of claim 2, wherein the characteristic consumption time for each respective segment represents an exposure time corresponding to complete consumption of the respective segment by a hypothetical user.

4. The method of claim 2, wherein the respective segment includes text, and the information density is based at least in part on the vocabulary and the sentence construction of the text.

5. The method of claim 2, wherein the respective segment is a photograph, and the information density is based at least in part on the complexity of the image in the photograph.

6. The method of claim 2, wherein the respective segment is a portion of a video, and the information density is based at least in part on a factor selected from the group consisting of: an amount of dialog in the segment; complexity of dialogue in the segment; whether the segment includes an action sequence; and the location of the segment in the video.

7. The method of claim 1, wherein generating the media engagement metric further includes standardizing the respective exposure times based at least in part on a historical average consumption rate of the one or more users.

8. The method of claim 7, wherein the one or more users corresponds to all users for which exposure times for the respective segments of the media content item are available.

9. The method of claim 7, wherein the one or more users corresponds to a plurality of users having a common psychographic group.

10. The method of claim 7, wherein the one or more users corresponds to a plurality of users in a particular age range.

11. The method of claim 7, wherein the one or more users corresponds to a single user.

12. The method of claim 1, further comprising predicting an engagement level for an additional media content item based at least in part on similarities between the media content item and the additional media content item.

13. The method of claim 1, further comprising determining an engagement profile for the media content item based on the media engagement metrics for each of the plurality of segments of the media content item.

14. The method of claim 1, wherein the media content item includes text, and wherein each segment of the plurality of respective segments corresponds to a respective textual segment of the text.

15. The method of claim 1, wherein the media content item is a video, and wherein each segment of the plurality of respective segments corresponds to a respective video segment of the video.

16. The method of claim 1, wherein the media content item is a plurality of images, and wherein each segment of the plurality of respective segments corresponds to a respective image of the plurality of images.

17. The method of claim 1, wherein the media content item is a game, and wherein each segment of the plurality of respective segments corresponds to a respective gameplay segment of the game.

18. The method of claim 1, further comprising generating a consolidated media engagement metric for the media content item based at least in part on the media engagement metrics for each of the plurality of segments of the media content item.

19. An electronic device, comprising:
one or more processors;
memory; and
one or more programs, wherein the one or more programs are stored in the memory and configured to be executed by the one or more processors, the one or more programs including instructions for:
receiving, from each of one or more users, respective exposure times for one or more respective segments of a media content item, wherein the media content item is divided into a plurality of respective segments;
generating, for each user of the one or more users, a media engagement metric for each of the plurality of segments of the media content item, wherein generating the media engagement metric includes standardizing the respective exposure times based at least in part on a characteristic consumption time for each respective segment of the media content item; and
storing, for each of the one or more users, the media engagement metric for each of the plurality of segments of the media content item in association with a user identifier.

20. A non-transitory computer readable storage medium storing one or more programs, the one or more programs comprising instructions, which when executed by an electronic device, cause the device to:
receive, from each of one or more users, respective exposure times for one or more respective segments of a media content item, wherein the media content item is divided into a plurality of respective segments;
generate, for each user of the one or more users, a media engagement metric for each of the plurality of segments of the media content item, wherein generating the media engagement metric includes standardizing the respective exposure times based at least in part on a characteristic consumption time for each respective segment of the media content item; and
store, for each of the one or more users, the media engagement metric for each of the plurality of segments of the media content item in association with a user identifier.
